(19) United States
(12) Patent Application Publication
(10) Pub. No.: US 2003/0064284 A1
(43) Pub. Date: Apr. 3, 2003

(54) Nonaqueous electrolyte battery and method of manufacturing same

(75) Inventors: Yasuhiro Yoshida, Tokyo (JP); Osamu Hiroi, Tokyo (JP); Tetsuyuki Kurata, Tokyo (JP); Takashi Nishimura, Tokyo (JP); Syoji Yoshioka, Tokyo (JP); Shigeru Aihara, Tokyo (JP); Daigo Takemura, Tokyo (JP); Hironori Kuriki, Tokyo (JP); Jun Aragane, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/158,056

(22) Filed: May 31, 2002

(30) Foreign Application Priority Data
Sep. 28, 2001 (JP) 2001-298878

(51) Int. Cl. H01M 2/02; H01M 2/08; H01M 10/04

(52) U.S. Cl. 429/162; 429/181; 29/623.2; 29/623.4

(57) ABSTRACT

The present invention provides a nonaqueous electrolyte battery, of which impact resistance can be enhanced. The nonaqueous electrolyte battery comprising a flat electric power generating element, a baglike container, leads, and a resin for fixing surfaces of a thin portion of the electric power generating element and an inner surface of the baglike container together.

### BACKGROUND OF THE INVENTION

1. Technical Field

The invention relates to a battery having a nonaqueous electrolyte. More specifically, the invention relates to a battery, of which impact resistance can be readily enhanced without application of a complex construction on a nonaqueous electrolyte battery, and a method of manufacturing the same.

2. Background Art

A container for batteries, intended for lightening is used to be formed baglike from a laminate film composed of a metallic foil such as aluminum and a heat sealable film. Being small in mechanical strength as compared with conventional containers, such lightened container is in need of contrivance for ensuring reliability in the case where a battery is subjected to impact such as falling and various types of deforming pressures. While the laminate film itself is reinforced by a protective film or the like, containers formed therefrom are low in rigidity and also in the function of protecting an electric power generating element of a battery contained therein. Therefore, there is a need of not only measures for damage against the laminate film itself but also measures for protecting an electric power generating element of a battery contained therein. There have been proposed various ways to ensure reliability against impact and deforming pressures on an electric power generating element of a battery.

A method of bonding an electric-power generating element and a container together is shown in, for example, Japanese Patent Laid-Open No. 93576/2001. This method can provide for an excellent resistance against impact and vibrations.

As disclosed in, for example, Japanese Patent Laid-Open No. 118566/2001, there has been also proposed a method of enhancing strength by mounting reinforcing members to lead portions taken out of an electric power generating element. When this method is used to collect and electrically connect a plurality of leads to terminals at the manufacture of batteries, it is possible to prevent breakage of leads at lead taken-out bases.

As for lightened containers, rigidity of a container is low and so forces for fixation of an electric power generating element contained therein are weak. Therefore, large shock or the like may cause positional deviation between an electric power generating element and a container to lead to damage against lead portions or the like, by which electric current is taken outside the container from the electric power generating element.

When it is tried to apply on a lightened container the way to bond an electric power generating element and a container together as disclosed in Japanese Patent Laid-Open No. 93576/2001, there are caused problems that strong bonding with common adhesives and an adhesive material is made difficult due to the presence of a film layer for heat sealing on an inner surface of a laminate film and an increase in thickness due to bonding is not preferable in thin batteries assumed by a lightened container.

### DISCLOSURE OF THE INVENTION

The invention has been thought of in order to solve such problems, and provides a nonaqueous electrolyte battery, in which a container and an electric power generating element therein are surely fixed together in a battery making use of a lightened container and damage can be suppressed even upon application of impact and deforming pressure, and a method of manufacturing the same.

This object and advantages are achieved by providing a novel and improved nonaqueous electrolyte battery comprising a flat electric power generating element, in which positive electrode plates and negative electrode plates are laminated, a baglike container receiving therein the electric power generating element and formed from a resin film, leads connected to the positive electrode plates and the negative electrode plates, respectively, and taken out of the baglike container through heat sealed portions of the baglike container, and a resin for fixing surfaces of a thin portion of the electric power generating element and an inner surface of the baglike container together.

Further, according to one aspect of the invention, there is provided a method of manufacturing a nonaqueous electrolyte battery comprising a flat electric power generating element, in which positive electrode plates and negative electrode plates are laminated, a baglike container receiving therein the electric power generating element and formed from a resin film, and leads connected to the positive electrode plates and the negative electrode plates, respectively, and taken out of the baglike container through heat sealed portions of the baglike container, the method comprising the step of inserting a resin between surfaces of a thin portion of the electric power generating element and an inner surface of the baglike container, the resin acting to fix the surfaces of the thin portion of the electric power generating element and the inner surface of the baglike container together.

The above object and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a plan view showing an example of a nonaqueous electrolyte battery according to the invention, in which a resin is used to fix an electric power generating element and a baglike container together in positions on a side where leads are present and on a side opposite thereto;

FIG. 2 is a plan view showing an example of a nonaqueous electrolyte battery according to the invention, in which a resin is used to fix an electric power generating element and a baglike container together in a position on a side where leads are present;

FIG. 3 is a plan view showing an example of a nonaqueous electrolyte battery according to the invention, in which a resin is used to fix an electric power generating element and a baglike container together in a plurality of positions including a side where leads are present;

FIG. 4 is a plan view showing an example of a nonaqueous electrolyte battery according to the invention, in which a resin is used to fix an electric power generating element and a baglike container together in positions of four corners of the electric power generating element;

FIG. 5 is a plan view showing an example of a nonaqueous electrolyte battery according to the invention, in which a resin is used to fix an electric power generating element and a baglike container together in a major part of a gap between the electric power generating element and the baglike container;

FIG. 6 is a plan view showing an example of a nonaqueous electrolyte battery according to the invention, in which a battery is received in a protective container having projections on its inner surface such that a resin and the projections of the protective container are brought into indirect contact with each other through a baglike container to fix the battery;

FIG. 7 is a cross sectional view showing an example of a nonaqueous electrolyte battery according to the invention, in which a battery is received in a protective container having projections on its inner surface such that a resin and the projections of the protective container are brought into indirect contact with each other through a baglike container to fix the battery, as viewed from a side of leads;

FIG. 8 is a view showing an example of the manufacture flowchart of a nonaqueous electrolyte battery in the case where a resin in flow condition being supplied between an electric power generating element and a baglike container is a thermoplastic resin, in an embodiment of the invention; and

FIG. 9 is a view showing an example of the manufacture flowchart of a nonaqueous electrolyte battery in the case where a resin in flow condition being supplied between an electric power generating element and a baglike container is a thermosetting resin, in an embodiment of the invention.

### BEST MODE FOR CARRYING OUT THE INVENTION

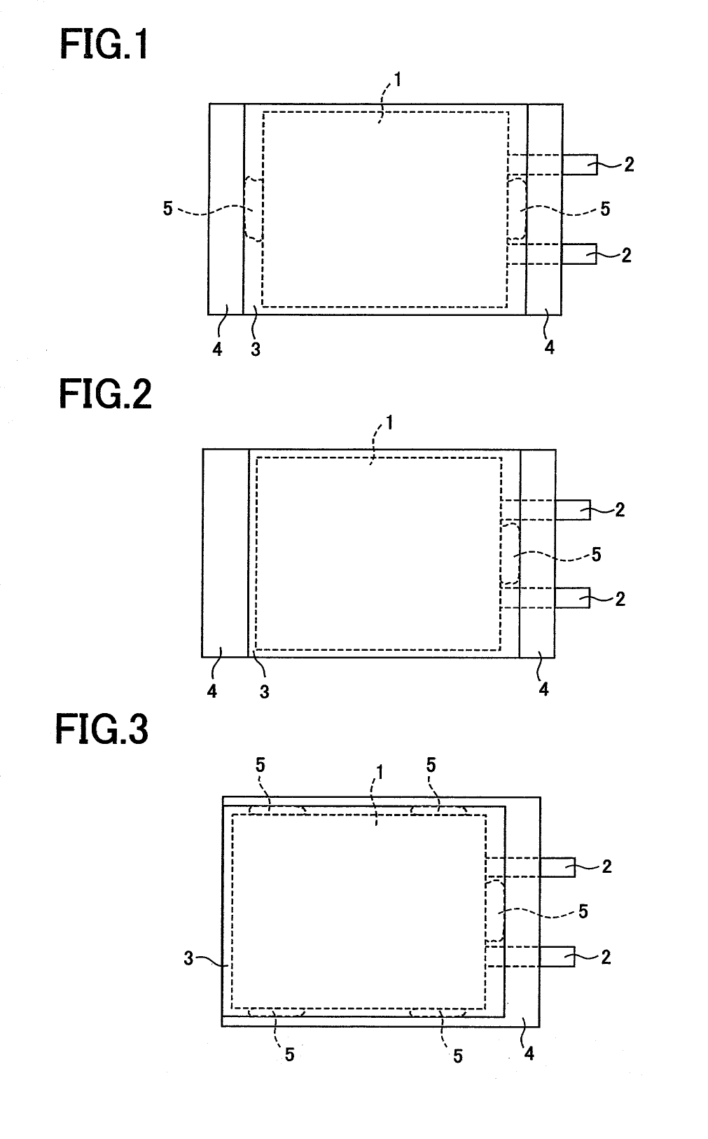

An explanation will be given to main constituent elements, constitution and a manufacturing method of a nonaqueous electrolyte battery according to the invention. In FIGS. 1 to 7, numeral 1 designates an electric power generating element; numeral 2 designates leads; numeral 3 designates a baglike container; numeral 4 designates a heat sealed portion; numeral 5 designates a resin; and numeral 6 designates a protective container.

Electric Power Generating Element

Electrode plates in the invention are used which comprise an active material coated on a collector. Positive electrode plates can use, as an active material, ones having oxides of transition metals, for example, cobalt, manganese, or nickel, chalcogenides, or conjugated compounds thereof, various additional elements. While carbonaceous materials are preferably used in negative electrode plates, they can be used irrespective of chemical properties in a battery of the invention. An active material making use of metallic lithium is also usable. In the case of metallic lithium, an active material in the form of either powder or foil will do while other active materials are used in the form of powder. An active material having the particle size of 0.3 to 20 μm is usable. In particular, an active material having the particle size of 1 to 5 μm is preferable. In the case of the particle size being too small, an area of active material surfaces covered by an adhesive at the time of bonding becomes excessively large, so that an associated battery will be degraded in performance since doping and de-doping of lithium ions at the time of charging and discharging are not efficiently effected. In the case of the particle size being too large, it is not preferable because thin filming is not easy, the packing density is decreased, and irregularities on surf aces of electrode plates thus formed become large to make unfavorable bonding with a separator. A collector formed of a metal which is stable in a battery is usable, aluminum being preferably used for positive electrode plates and copper being preferably used for negative electrode plates. Any one of foil, mesh, expanded metal and the like is usable for the configuration of a collector. Leads connected to positive electrode plates and negative electrode plates may be ones formed from a metal such as aluminum, or nickel and mounted on a collector and ones comprising collector portions taken out and not coated with an active material.

An electric power generating element of a battery may be constructed such that positive electrode plates correspond closely to negative electrode plates and a gap therebetween is filled with an electrolyte or may be constructed such that planar elements overlap one another, or may be of winding pattern construction, or of folded construction or of composite construction of the above-mentioned constructions.

The electric power generating element is preferably flat-shaped to be 1.5 times or more as wide as a thickness of the electric power generating element. More preferably, the width is three times or more as large as the thickness. In the case where the width is too small relative to the thickness, that is, the electric power generating element is small in flatness, insertion of a resin is not easy. There is caused a problem that even when such insertion is possible, a container cannot be well fixed due to deformation or the like.

Leads are taken out of edge surface portions of an electric power generating element, and when a plurality of electrode plates are stacked on one another, a plurality of leads taken out of the electrode plates are in many cases connected together and taken out of a battery container. In the case of being of winding pattern construction, or of folded construction, leads are in some cases taken out of portions on ends of cross sections of an electric power generating element when they are taken out of central portions of cross sections of the electric power generating element. In this manner, while there are various ways, in which leads are taken out, no specific problem is caused when leads taken out of positive electrode plates and negative electrode plates are brought into no contact with one another and arranged so that electric current is efficiently produced from the electric power generating element. These leads may be coated or laminated with a resin for the sake of an increase in insulation and strength or of an improved reliability in heat sealing.

Container

A container in the invention may be either a can type container formed from a metal such as stainless steel, or aluminum, or a container formed by working a film into a baglike configuration. The invention is greatly effective for containers, of which strength is small, such as ones formed from a film. Here, the film suffices to be sealed by heat sealing to prevent leakage of an electrolytic solution from an interior of a battery and entry of moisture content from outside the battery. While a resin film having a heat sealing property can be used for seal portions, it is desired that the barrier property be improved by vapor deposition of a metal, coating with plating or the like, or lamination of a metal foil of aluminum or the like. In the case of a metal foil being used, a resin film can be dispensed with when the foil has an adequate thickness, while an aluminum foil having a thickness of several microns to several tens of microns and laminated with a resin is generally used for the sake of lightening. It is desired that a film of polyethylene, polypropylene or the like be laminated on an inner surface of the foil to provide for the heat sealing property and a film of polyethylene terephthalate or stretch nylon be laminated on an outer surface of the foil to provide for an increase in strength.

Various methods of forming a container formed from a film are applicable, and include a method of double folding a square-cut film sheet and heat sealing three sides thereof, a method of heat sealing both opening portions of a cylindrical-shaped film and the like. A container material is in some cases used in a state of being cut intact while it is also used after a recess conformed to an electric power generating element has been formed by means of a press or the like. It is also possible to cut or bend a surplus container material after heat sealing.

In many cases, heat sealing is carried out by interposing between wire-like heaters container portions being sealed. At this time, it is desired that the heaters be coated by polytetrafluoroethylene or the like so as to prevent a film being a container material from being melt and fused. Planar heating surfaces are in many cases used but irregularities may be formed conformed to a configuration of a battery or leads. Heater temperature is in many cases in the range of 100 to 200° C. but must be higher than a fusing point of a film resin since sealing becomes insufficient when the temperature is below the fusing point. Also, the heat sealing time is in many cases in the range of 1 to 15 seconds. Further, pressure at the time of heat sealing is in many cases in the range of 3 to to 100 g/cm². Since the heater temperature, heat sealing time and pressure assume different optimum values depending upon material, thickness, configuration or the like of a container material, however, they are not limited to the above-mentioned ranges. There is also a method of repeating the heat sealing process on the same area several times to provide for more sure sealing.

Other Constituents

An electrolyte may be liquid or gel. The electrolyte includes, as an organic low molecular compound, ethers such as dimethoxyethane, and diethyl ether, esters such as ethylene carbonate, and propylene carbonate, singularly or in combination. Other additives may be included. LiPF₆, LiClO₄, LiBF₄ and so on are usable as salt contained in the electrolyte.

In the case where the electrolyte is gel, there are no specific limitations on a method of making gel, and a material, but it is desired that the gel contain an electrolytic solution in its polymer component and an electrolytic solution content be 20 wt. percents to 98 wt. percents. When the electrolytic solution content is below 20 wt. percents, the gel itself will become exceedingly low in ionic conductivity and so an adequate ionic conductivity cannot be given to an electrolyte layer when a battery is formed. Also, when the electrolytic solution content is above 98 wt. percents, the gel becomes exceedingly low in strength, so that an effect of forming gel is small. The gel may be mixed with inorganic fine particle such as silica, or alumina. This can in some cases make the gel porous to improve ionic conductivity and prevent short circuit between positive electrode plates and negative electrode plates. A polymer component is not specifically limitative but can use a resin such as methacrylate and acrylic monomers, polymer containing as its principal chain monomers such as alkylene oxide, acrylonitrile, ethylene, styrene, vinyl alcohol, and vinylpyrrolidone, homopolymer of polyvinylidene fluoride and so on, copolymer or the like.

When the electrolyte is liquid, a separator is necessary. When the electrolyte is gel, a battery in some cases functions even without any separator, in which case a separator may be provided. As the separator, a suitable one having an adequate strength is chosen from insulating porous films, mesh, nonwoven cloth and the like. Although being not limitative, the use of a porous film formed from a thermoplastic resin such as polypropylene, polyethylene or the like is preferable from the point of view in improvement in adhesiveness, enhancement in ionic conductivity and in prevention of short circuit between positive electrode plates and negative electrode plates.

Constitution of a Battery

A battery according to the invention is constructed such that an electric power generating element with positive electrode plates and negative electrode plates laminated on one another is received in a container. In the case of a container formed from a metallic can, leads are connected to conductors insulated from the metallic can to ensure conduction of electric current to outside a battery. In the case of a container formed from a film, leads attached to an electric power generating element are taken out through a heat sealed portion.

Fixation of the electric power generating element and the container with the use of a resin is effective in suppressing deformation of leads in the case where a battery is subjected to impact or deforming pressure.

It is required that a resin inserted be disposed on a surface of a thin portion of a flat-shaped electric power generating element. There is caused no problem in the battery characteristics even when the resin goes beyond the surface of the thin portion of the electric power generating element, but there is in some cases caused a disadvantage that a battery becomes large in thickness in accordance with an amount of the resin, which goes beyond the surface. Some resins may be inserted into any area provided that an electric power generating element and a container can be favorably fixed together. Byway of several examples, an explanation will be concretely given to an effect obtained by insertion of a resin. An example is illustrated in a battery constructed such that a container formed by working a film into a cylindrical-shape is used and leads are taken outside through heat sealed portions of the container.

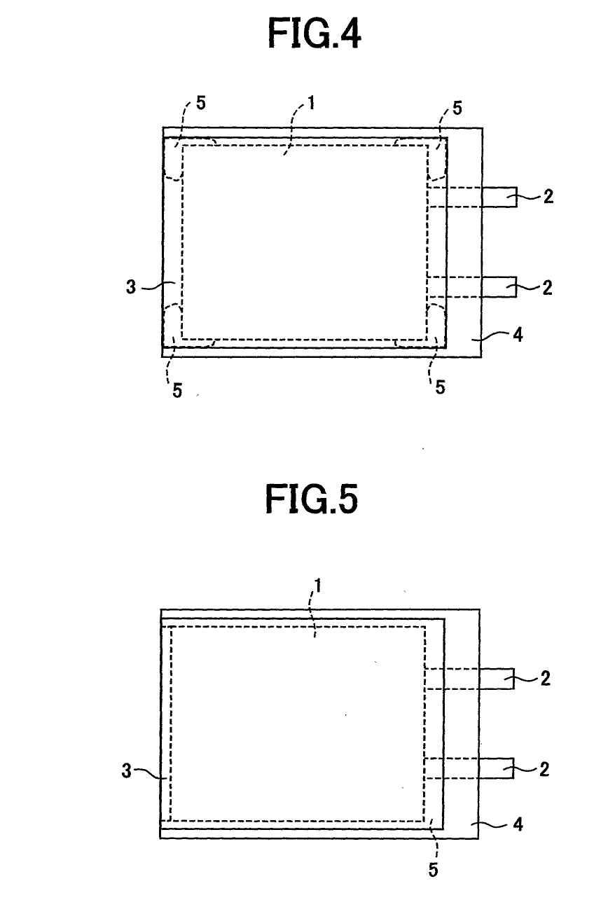

There is a method of inserting a resin 5 into a larger one of gaps between a baglike container 3 and an electric power generating element 1 as shown in FIG. 1. Leads 2 are taken out of heat sealed portions 4. Since the gap is large and fixation is effected in a direction, in which the electric power generating element is liable to move, the impact resistance can be efficiently improved. There is a method of inserting the resin 5 into a side where the leads 2 are present, as shown in FIG. 2. This can surely protect lead portions which are susceptible of damage. Besides, there is illustrated a container construction, in which a recess conformed to the electric power generating element is formed on a square-cut film by means of a press and the film is double-folded to be bag-shaped. There is a method of inserting the resin 5 into many regions to make fixation of the electric power generating element 1 more sure as illustrated in FIG. 3. There is a method of inserting a resin 5 into corner portions of the electric power generating element 1 as illustrated in FIG. 4. This can efficiently protect the corner portions of the electric power generating element, which are susceptible of damage upon drop or the like. There is a method of filling the resin 5 in a major part of the gap as illustrated in FIG. 5. This can make a battery exceedingly high in rigidity. An effect of enhancing strength in sealed portions is obtained by inserting a resin along the sealed portions.

Method of Manufacturing a Battery

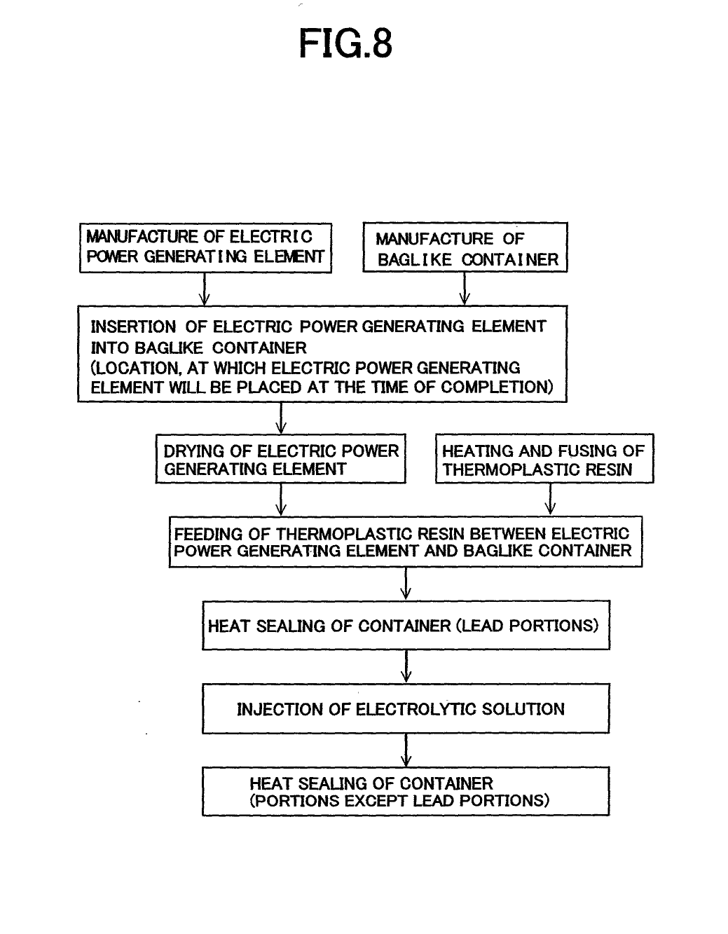

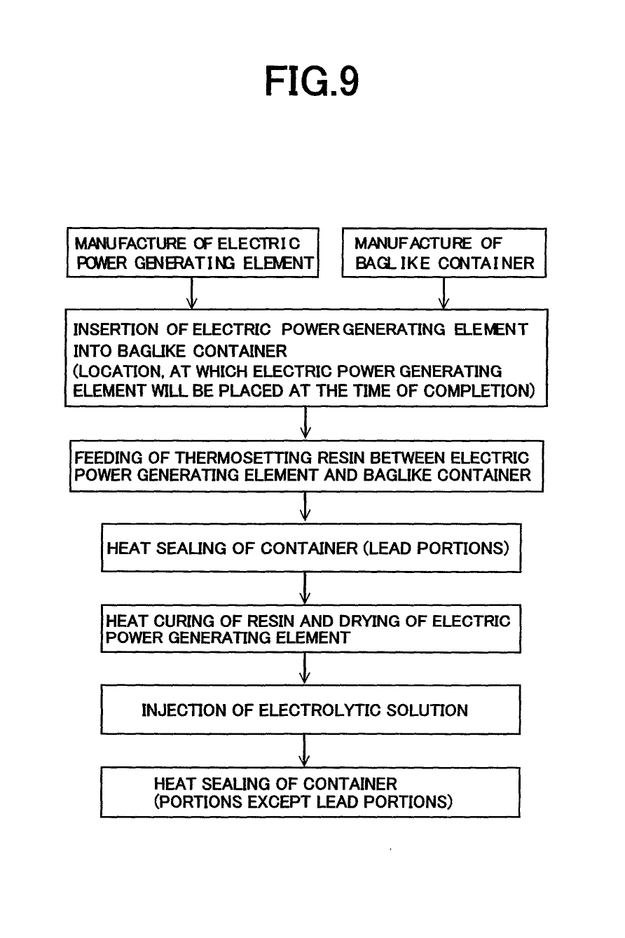

With respect to a method of manufacturing a battery, FIG. 8 shows an example of the manufacture flowchart of a nonaqueous electrolyte battery in the case where a resin in a flow condition being supplied into between an electric power generating element and a baglike container is a thermoplastic resin. Also, FIG. 9 shows an example of the manufacture flowchart of a nonaqueous electrolyte battery in the case where a resin in a flow condition being supplied into between an electric power generating element and a baglike container is a thermosetting resin. An explanation will be given below to respective processes.

An electric power generating element with leads connected thereto and a container enclosing the electric power generating element and formed into a predetermined configuration in a manner to enable manufacture of a battery are beforehand fabricated, and the electric power generating element is arranged in a predetermined position for the container. Thereafter the container is sealed to form a battery. There are ways to beforehand impregnate the electric power generating element with an electrolytic solution and to add an electrolytic solution after the electric power generating element is placed at a predetermined position in the baglike container.

A resin being inserted into between an electric power generating element and a container is insertable in an optional stage of battery manufacturing processes. There are ways to beforehand adhere a resin. before placing an electric power generating element in a container and to supply a resin after the electric power generating element is placed at a predetermined position in the container. Even in the case where a resin being used possesses stickiness and is susceptible to deformation or flow to become difficult to handle when it is beforehand adhered to the electric power generating element, the use of the latter way can advantageously form a battery with ease. Also, a resin having need of heating and drying processes in beforehand adhering to an electric power generating element is advantageous in that it is inserted into gaps between an electric power generating element and leads to omit surplus processes and to enable easy fixation.

As a resin being inserted into gaps between an electric power generating element and a container, ones having plasticity or flow property can be used. In this case, it becomes possible to easily insert a resin into spaces between an electric power generating element and a container. There are produced an effect that gaps are efficiently filled and fixation is made more sure, and also an effect that a battery is reduced in volume and in weight due to reduction of an amount of the resin since fixation is enabled in a less space.

Various kinds of resins are usable except ones that possess no conductivity and are not dissolved in the electrolytic solution. Homopolymer or copolymer can be preferably used to be in many cases highly stable against the electrolytic solution and to include, as its constituent component, for example, olefin derivatives such as ethylene, propylene, isobutylene, propene, butene, 3-methyl-1-butene, or cyclohexene, halogenated ethylene derivatives such as polyvinyl chloride, vinylidene chloride, polyvinyl fluoride, or polyvinylidene fluoride, diene derivatives such as butadiene, isoprene or the like, styrene derivatives such as styrene, chlorostyrene or the like, vinylester derivatives such as vinyl acetate, vinyl ether derivatives such as methyl vinyl ether, or phenyl vinyl ether, derivatives such as acrylic and methacrylate esters, or amides, maleate, maleimide derivatives or the like. These resins may be used in a state, in which they are mixed with various solvents, but many of them exhibit plasticity at the time of heating or the like and so can be also used without any solvent.

It is also possible to use resins such as polyphenylene sulfide, polyphenylene oxide, polycarbonate, acetal resin, or polyamide. When these resins are to be used, solutions or precursor solutions are used. Some of these resins are excellent in chemical stability, mechanical stability and electrical insulation and thus can be preferably used.

It is also possible to use thermosetting resins such as unsaturated polyester resin, epoxy resin, phenol resin, urea resin, melamine resin, silicone resin, and diallyl phthalate resin. When these resins are used, solutions or precursor solutions are used. In the case of using these thermosetting resins, it is preferable to perform adequate heat curing. Thereby it is not only possible to adequately lower solubility and swelling property for the electrolytic solution but also to make strength of a resin considerably large, so that protection of a battery can be more surely effected. When such heat curing is carried out at the time of heat sealing of a baglike container or at the time of drying of an electric power generating element, simplification of processes can be preferably effected.

As described above, multiple resins are usable, and various advantages are produced particularly in the case of using a thermoplastic resin. When melted, a thermoplastic resin can be easily fixed to an electric power generating element or a container and inserted into gaps between the electric power generating element and the container. Generally, when a polyolefine resin called a hot melt adhesive is used, it can be easily bonded and more surely fixed to inner surfaces of a baglike container, to which ordinary adhesives are frequently difficult to adhere. Further, in the case of using a thermoplastic resin, heat generated at the time of sealing of a container effected by means of welding of a metallic container or heat sealing of a baglike container is made use of to enable advantageously ensuring fixation of the electric power generating element and the container. In the case of use without any solvent, there are produced advantages that there is no need of any drying process and exhaust equipments or the like and that fixation is made more sure due to no volumetric shrinkage accompanying evaporation of a solvent. Also, while in some cases a resin goes beyond surfaces of thin portions of an electric power generating element to make a battery large in thickness, there is also produced an advantage that such thickening can be simply corrected by means of a hot press or the like.

The fusing point of a thermoplastic resin is preferable in the range of 60° C. to 200° C. In the case of the fusing point being below 60° C., there is the possibility that the resin flows at high temperature as when a battery operates. In particular, in the case where a large amount of electrolytic solution is present in a battery, the electrolytic solution is liable to cause a resin to swell to flow. When the fusing point is above 200° C., there is the possibility that heating required for fixation adversely affects the characteristics of a battery. When the fusing point of a thermoplastic resin is in the above range but is lower than the heat sealing temperature of a baglike container, even ordinary heat sealing of the baglike container causes a heat sealed resin to flow, thus obtaining an advantage that sure fixation is made possible without the need of any special heating.

Further, the fusing point of a thermoplastic resin is more preferably in the range of 80° C. to 140° C. with a view to considerably decreasing the possibility that the resin flows at high temperature as when a battery operates and adverse influence on the characteristics of a battery caused by heating required for fixation. The invention will be explained in more detail with reference to the following examples.

### COMPARATIVE EXAMPLE 1

A positive electrode active material paste made up of LiCoO₂ of 87 wt. percents, graphite powder KS-6 of 8 wt. percents, and polyvinylidene fluoride of 5 wt. percents as a binder resin was coated on an aluminum foil, as a collector, having a thickness of 20 μm by the doctor blade method to have a thickness of about 100 μm, thus forming positive electrode plates.

A negative electrode active material paste made up of mesophase microbead carbon (manufactured by Osaka Gas Ltd.) of 95 wt. percents, and polyvinylidene fluoride of 5 wt. percents as a binder was coated on a copper foil, as a collector, having a thickness of 12 μm by the doctor blade method to have a thickness of about 100 μm, thus forming negative electrode plates.

Manufacture of Electric Power Generating Element

Aluminum leads for the positive electrode plates and nickel leads for the negative electrode plates were manufactured for a collector sized to be of 5 mm×55 mm×0.25 mm, and a denatured polyethylene film having a width of 6 mm was heat sealed to heat sealed portions of an aluminum laminated container. Positive electrodes plate and negative electrode plates were cut to have a size of 50 mm×200 mm, and the leads were mounted to a collector foil by means of ultrasonic welding. A separator cut to have a size of 52 mm×210 mm was interposed between the positive electrode plates and the negative electrode plates, wound so that it had a width of about 40 mm and the leads came to its core portion, and fixed by a kapton tape (Kapton is the registered trademark of Du Pont Ltd.). At this time, the leads were put into a state to extend 15 mm from the positive electrode plates and the negative electrode plates thus wound. In this way, a flat electric power generating element to have a size of about 40 mm×50 mm was obtained.

Manufacture of Containers

An aluminum laminated film cut to a size of 102 mm×58 mm and having polypropylene as a heat sealing resin was double-folded to a size of 51 mm×58 mm, its short sides being heat sealed over a width of about 5 mm to provide a cylindrical shape. Heat sealing was carried out with the use of FCB-270 manufactured by Fuji Impulse Ltd., in which the heater temperature was 180° C., the heat sealing time was 10 seconds, and pressure at the time of heat sealing was 30 g/cm².

Completion of Battery

An electric power generating element was inserted into the cylindrical-shaped container to be sufficiently dried. Portions heat sealed to provide a cylindrical shape were positioned between leads of the electric power generating element. Thereafter, one side toward the leads was heat sealed. An electrolytic solution containing ethylene carbonate and 1,2-dimethoxyethane as a solvent and lithium phosphate hexafluoride as an electrolyte was injected from one side not subjected to heat sealing, and an aluminum laminated film was sealed to complete a battery.

Estimation of Impact Resistance

The batteries thus manufactured were dropped on the floor from a level of 1.5 m. Drop with the lead portions downward and drop with the lead portions upward were alternately repeated. After drop was made twenty times, the batteries were disassembled and a state of breakage in the interior of the batteries was examined. As a result, it has been recognized that the lead portions inside three ones among five test batteries were cracked and that the batteries were made abnormal in function due to short circuit between a positive electrode plate and a negative electrode plate.

### COMPARATIVE EXAMPLE 2

Manufacture of batteries and estimation of impact resistance were conducted in the same manner as in Comparative example 1 except that containers were manufactured in the following way.

Manufacture of Containers

A recess having a size of 41 mm×55 mm and a depth of 4 mm was formed by means of a press, in a location where an electric power generating element was to be arranged, on an aluminum laminated film cut to a size of 128 mm×60 mm and having polypropylene as a heat sealing resin. The semi-product was double-folded and heat sealed over a width of about 6 mm at two sides interposing therebetween an electric power generating element manufactured in the same manner as in Comparative example 1 and including lead portions. Heat sealing was carried out with the use of FCB-270 manufactured by Fuji Impulse Ltd., in which the heater temperature was 180° C., the heat sealing time was 10 seconds, and pressure at the time of heat sealing was 30 g/cm².

After the semi-product was dried, an electrolytic solution was injected from the remaining one side in the same manner as in Comparative example 1 and the one side was sealed to complete a battery. As a result of estimation of impact resistance, it has been recognized that the lead portions inside four ones among five test batteries were cracked and that the batteries were made abnormal in function due to short circuit between a positive electrode plate and a negative electrode plate.

### EXAMPLE 1

Electric power generating elements having been manufactured in the same manner as in Comparative example 1 and containers having been manufactured in the same manner as in Comparative example 1 were used, and a polyethylene hot melt resin having a fusing point of 105° C. was inserted as a resin 5 into a location shown in FIG. 1. After the electric power generating element was inserted into the cylindrical-shaped container, a small amount of polyethylene hot melt resin was discharged from a heating nozzle to be adhered. Heat sealing of the lead portions and the opposed sides thereto caused the hot melt resin to again flow to have no influence on a configuration of a battery. Also, this could fix the electric power generating element and the container together.

Thereafter, batteries were completed in the same manner as in Comparative example 1 and estimation of impact resistance was conducted. As a result, no crack was recognized in the lead portions of all five test batteries and the batteries were normal in function.

### EXAMPLE 2

Electric power generating elements having been manufactured in the same manner as in Comparative example 1 and containers having been manufactured in the same manner as in Comparative example 1 were used, and a polyethylene hot melt resin having a fusing point of 86° C. was inserted as a resin 5 into a location shown in FIG. 2 to complete batteries.

Thereafter, batteries were completed in the same manner as in Comparative example 1 and estimation of impact resistance was conducted. As a result, no crack was recognized in the lead portions of all five test batteries and the batteries were normal in function.

### EXAMPLE 3

Electric power generating elements having been formed in the same manner as in Comparative example 1 and containers having been manufactured in the same manner as in Comparative example 2 were used, and after an electric power generating element was fitted into a recess of a container to be placed in a location, which would be at the time of completion of a battery, a small amount of polyurethane adhesive (Coronate L, Nippon polyurethane) was adhered as a resin 5 to a location shown in FIG. 3. An adhesive could be inserted into a gap between the electric power generating element and the container. Thereafter, the lead portions were heat sealed and heated for four hours at 80° C. for the purpose of drying of the electric power generating element and heat curing of the polyurethane adhesive.

Thereafter, batteries were completed in the same manner as in Comparative example 1, and estimation of impact resistance was conducted. As a result, no crack was recognized in the lead portions of all five test batteries and the batteries were normal in function.

### EXAMPLE 4

Electric power generating elements having been formed in the same manner as in Comparative example 1 and containers having been manufactured in the same manner as in Comparative example 2 were used, and after an electric power generating element was fitted into a recess of a container to be placed in a location, which would be at the time of completion of a battery, a small amount of polyethylene hot melt resin having a fusing point of 86° C. was discharged as a resin 5 to a location shown in FIG. 3 from a heating nozzle. The polyethylene hot melt resin could be inserted into gaps between the electric power generating element and the container.

Thereafter, batteries were completed in the same manner as in Comparative example 1 and estimation of impact resistance was conducted. As a result, no crack was recognized in the lead portions of all five test batteries and the batteries were normal in function.

### EXAMPLE 5

Electric power generating elements having been formed in the same manner as in Comparative example 1 and containers having been manufactured in the same manner as in Comparative example 2 were used, and after an electric power generating element was fitted into a recess of a container to be placed in a location, which would be at the time of completion of a battery, a small amount of polyethylene hot melt resin having a fusing point of 86° C. was discharged as a resin 5 to a location shown in FIG. 4 from a heating nozzle. The polyethylene hot melt resin could be inserted into gaps between the electric power generating element and the container.

Thereafter, batteries were completed in the same manner as in Comparative example 1 and estimation of impact resistance was conducted. As a result, no crack was recognized in the lead portions of all five test batteries and the batteries were normal in function.

### EXAMPLE 6

Electric power generating elements having been formed in the same manner as in Comparative example 1 and containers having been manufactured in the same manner as in Comparative example 2 were used, and after an electric power generating element was fitted into a recess of a container to be placed in a location, which would be at the time of completion of a battery, a small amount of polyethylene hot melt resin having a fusing point of 86° C. was discharged as a resin 5 to a location shown in FIG. 3 from a heating nozzle. The polyethylene hot melt resin could be inserted into gaps between the electric power generating element and the container.

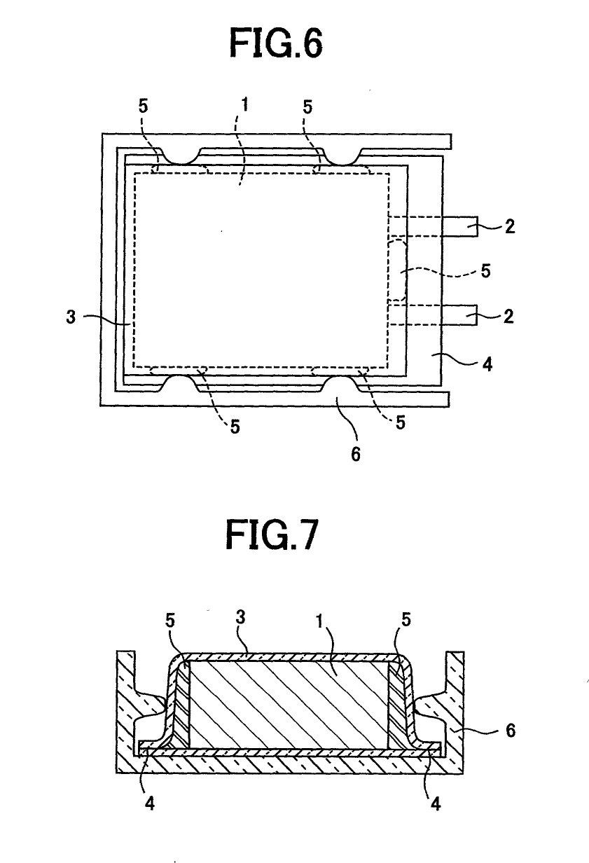

Thereafter, batteries were completed in the same manner as in Comparative example 1 and placed, as shown in FIGS. 6 and 7, in a protective container 6 formed of ABS resin. The protective container 6 includes projections on inner surfaces thereof, the projections being brought into contact with those portions of a container, into which the resin was inserted, to fix a battery.

In this state, impact resisting tests were carried out. As a result, no crack was recognized in the lead portions of all five test batteries and the batteries were normal in function.

### EXAMPLE 7

Electric power generating elements having been formed in the same manner as in Comparative example 1 and aluminum can type containers were used to complete batteries. First, an electrode terminal attached to a portion defining a cover of a aluminum can type container was connected to leads of an electric power generating element by means of welding. Thereafter, the electric power generating element was inserted into the aluminum can type container to be placed in a location, which would be at the time of completion of a battery, and sufficiently dried, and a small amount of polyethylene hot melt resin having a fusing point of 86° C. was discharged into an opening between surfaces of a thin portion of the electric power generating element and an inner surface of the can type container from a heating nozzle. The polyethylene hot melt resin could be inserted into gaps between the electric power generating element and the container.

Thereafter, an electrolytic solution containing ethylene carbonate and 1,2-dimethoxyethane as a solvent and lithium phosphate hexafluoride as an electrolyte was injected from the opening, and the opening was sealed by the aluminum cover, to which the electrode terminal was attached, and welded to complete a battery.

In this state, impact resisting tests were carried out. As a result, no crack was recognized in the lead portions of all five test batteries and the batteries were normal in function.

According to the invention, a nonaqueous electrolyte battery comprises a flat electric power generating element, in which leads are connected to positive electrode plates and negative electrode plates, respectively, and laminated, and a baglike container receiving therein the electric power generating element and formed from a resin film, the leads being taken out of heat sealed portions of the baglike container, the electric power generating element being fixed by inserting a resin between surfaces of a thin portion of the electric power generating element and an inner surface of the baglike container whereby positional deviation of the electric power generating element upon exertion of impact or deforming pressure on the battery is prevented and deformation of the leads is suppressed to provide a battery which is improved in impact resistance.

By using as a resin a thermoplastic resin having a lower fusing point than the heat sealing temperature of a baglike container, heat generated at the time of heat sealing of the baglike container can cause the thermoplastic resin to flow, so that a battery is obtained, in which heat sealing of the baglike container and fixation of the electric power generating element and the inner surface of the baglike container are effected in a packaged process. Since heat generated at the time of heat sealing of the baglike container is transmitted to the thermoplastic resin through a metallic layer of the baglike container having a good thermal conductivity and leads, adherence at inner surfaces of the baglike container and surfaces of the electric power generating element is made favorable to enable sure fixation.

By using as a resin a thermosetting resin having a lower curing temperature than the heat resisting temperatures of all the constituent elements of a battery, a battery is obtained, in which fixation of the electric power generating element and the inner surface of the baglike container can be effected in combination with the process of drying of the electric power generating element and curing of the thermosetting resin.

Further, deformation of leads upon exertion of impact or deforming pressure on the battery can be more surely prevented by receiving therein the battery thus obtained in the protective container having projections on its inner surface, and causing indirect contact between a resin inserted between the electric power generating element and the baglike container and the projections of the protective container with the baglike container therebetween to thereby fix the battery.

According to the invention, a nonaqueous electrolyte battery comprises a flat electric power generating element, in which leads are connected to positive electrode plates and negative electrode plates, respectively, and laminated, and a metallic can type container receiving therein the electric power generating element, an electric power generating element inserting opening of the can type container being sealed by welding after insertion of the electric power generating element, the electric power generating element being fixed by inserting a resin between surfaces of a thin portion of the electric power generating element and an inner surface of the can type container whereby positional deviation of the electric power generating element upon exertion of impact or deforming pressure on the battery is prevented and deformation of the leads is suppressed to provide a battery which is improved in impact resistance.

According to the invention, in a method of manufacturing a nonaqueous electrolyte battery comprising a flat electric power generating element, in which leads are connected to positive electrode plates and negative electrode plates, respectively, and laminated, and a baglike container receiving therein the electric power generating element and formed from a resin film, the leads being taken out of heat sealed portions of the baglike container, the electric power generating element being fixed by inserting a resin between surfaces of a thin portion of the electric power generating element and an inner surface of the baglike container whereby positional deviation of the electric power generating element upon exertion of impact or deforming pressure on the manufactured battery is prevented and deformation of the leads is suppressed to enable enhancing impact resistance of the battery.

Also, by feeding a resin between surfaces of a thin portion of the electric power generating element and an inner surface of the baglike container after the electric power generating element has been placed in a location, at which it will be placed at the time of completion of a battery, there is produced an effect that handling is not made difficult and the manufacture of a battery is made easy even in the case where a resin being used possesses stickiness and is susceptible to deformation or flow. Also, a resin having need of heating and drying processes in beforehand adhering the resin to the surfaces of the thin portion of the electric power generating element is inserted into gaps between the electric power generating element and the baglike container to enable omitting surplus processes and to enable easy fixation.

Further, by feeding a resin in a flow condition between the surfaces of the thin portion of the electric power generating element and the inner surface of the baglike container, it becomes possible to easily insert the resin into spaces between the baglike container and the electric power generating element. Therefore, gaps between the baglike container and the electric power generating element are efficiently filled and fixation is made more sure. Also, since fixation can be effected in less spaces, reduction of a battery in volume and reduction in weight due to reduction of an amount of the resin can be achieved.

By using as a resin a thermoplastic resin having a lower fusing point than the heat sealing temperature of a baglike container, heat generated at the time of heat sealing of the baglike container can cause the thermoplastic resin to flow, so that heat sealing of the baglike container and fixation of the electric power generating element and the inner surface of the baglike container can be effected in a packaged process. Since heat generated at the time of heat sealing of the baglike container is transmitted to the thermoplastic resin through a metallic layer of the baglike container having a good thermal conductivity and the leads, adherence at inner surfaces of the baglike container and surfaces of the electric power generating element is made favorable to enable sure fixation.

By using as a resin a thermosetting resin having a lower curing temperature than the heat resisting temperatures of all constituent elements of the battery, fixation of the electric power generating element and the inner surface of the baglike container can be effected in combination with the process of drying of the electric power generating element and curing of the thermosetting resin.

What is claimed is:

1. A nonaqueous electrolyte battery comprising a flat electric power generating element, in which positive electrode plates and negative electrode plates are laminated, a baglike container receiving therein the electric power generating element and formed from a resin film, leads connected to the positive electrode plates and the negative electrode plates, respectively, and taken out of the baglike container through heat sealed portions of the baglike container, and a resin for fixing surfaces of a thin portion of the electric power generating element and an inner surface of the baglike container together.

2. The nonaqueous electrolyte battery according to claim 1, wherein the resin is a thermoplastic resin having a lower fusing point than the heat sealing temperature of the baglike container.

3. The nonaqueous electrolyte battery according to claim 1, wherein the resin is a thermosetting resin having a lower curing temperature than the heat resisting temperatures of all constituent elements of the battery.

4. The nonaqueous electrolyte battery according to claim 1, further comprising a protective container receiving therein the battery, and wherein contact portions between the nonaqueous electrolyte battery and the protective container are disposed adjacent to a region where the resin is inserted between the surfaces of the thin portion of the electric power generating element and the inner surface of the baglike container together.

5. A nonaqueous electrolyte battery comprising a flat electric power generating element, in which positive electrode plates and negative electrode plates are laminated, a metallic container receiving therein the electric power generating element, leads connected to the positive electrode plates and the negative electrode plates, respectively, and a resin inserted between surfaces of a thin portion of the electric power generating element and an inner surface of the metallic container to fix the electric power generating element.

6. A method of manufacturing a nonaqueous electrolyte battery comprising a flat electric power generating element, in which positive electrode plates and negative electrode plates are laminated, a baglike container receiving therein the electric power generating element and formed from a resin film, and leads connected to the positive electrode plates and the negative electrode plates, respectively, and taken out of the baglike container through heat sealed portions of the baglike container, the method comprising the step of inserting a resin between surfaces of a thin portion of the electric power generating element and an inner surface of the baglike container, the resin acting to fix the surfaces of the thin portion of the electric power generating element and the inner surface of the baglike container together.

7. The method of manufacturing a nonaqueous electrolyte battery, according to claim 6, wherein the resin is fed between the surfaces of the thin portion of the electric power generating element and the inner surface of the baglike container after the electric power generating element has been placed in that location in the baglike container, at which it will be placed at the time of completion of the battery.

8. The method of manufacturing a nonaqueous electrolyte battery, according to claim 6, wherein the resin in flow condition is fed between the surfaces of the thin portion of the electric power generating element and the inner surface of the baglike container.

9. The method of manufacturing a nonaqueous electrolyte battery, according to claim 8, wherein the resin is a thermoplastic resin having a lower fusing point than the heat sealing temperature of the baglike container, and heat generated at the time of heat sealing of the baglike container causes the thermoplastic resin to flow.

10. The method of manufacturing a nonaqueous electrolyte battery, according to claim 8, wherein the resin is a thermosetting resin having a lower curing temperature than the heat resisting temperatures of all constituent elements of the battery, and the thermosetting resin is caused to cure after heat sealing of the baglike container.
